(19) United States
(12) Patent Application Publication
(10) Pub. No.: US 2010/0082372 A1
(43) Pub. Date: Apr. 1, 2010

(54) NETWORK-BASED HEALTHCARE DATA MANAGEMENT

(75) Inventors: Jie Wen, Beijing (CN); Kevin Luo, Beijing (CN); Sameer Bade, Washington, DC (US); Bei-Jing Guo, Seattle, WA (US); Lijiang Fang, Beijing (CN)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/466,574

(22) Filed: May 15, 2009

Related U.S. Application Data
(60) Provisional application No. 61/101,476, filed on Sep. 30, 2008.

(51) Int. Cl. G06Q 50/00

(52) U.S. Cl. 705/3; 705/2; 726/3; 713/151

(57) ABSTRACT

A web- or network-based healthcare management tool is provided. The innovation provides for a browser-based version of a client that enables clinicians, from remote locations, to securely review patient data retrieved from a healthcare data store. Remote locations include, but are not limited to, from outside the hospital (e.g., at home) or from inside the hospital but in an office or lab that does not have intranet access to the healthcare data store.

### CROSS REFERENCE TO RELATED APPLICATIONS

This application claims the benefit of U.S. Provisional Application No. 61/101,476 filed on Sep. 30, 2008, entitled “HEALTHCARE MANAGEMENT TOOL WEB ACCESS”. The entirety of this application is hereby incorporated by reference.

### BACKGROUND

A long-time effort among developers of data systems has been to connect disparate systems in order to transfer data from one system to another. Unfortunately, this has proven difficult because many systems are not designed to send outbound or receive inbound data, because various systems use different encoding and messaging standards, and because the mechanisms of data transfer that the system can handle may differ between various systems.

By way of example, a hospital's laboratory system may send data via a TCP/IP (Transmission Control Protocol/Internet Protocol) socket connection, in messages in the HL-7 v2.5 (pipe-delimited) format, with the message data encoded using the LOINC (Logical Observation Identifiers, Names and Codes) terminology standard. A downstream system that requires a laboratory data feed may only be able to receive data via FTP (File Transfer Protocol) connections, in messages encoded in XML (extensible markup language), with the message data encoded using the SNOMED (Systemized Nomenclature of Human and Veterinary Medicine) terminology standard.

While recent developments have been focused around providing systems that aggregate healthcare data of different formats, conventional systems are local applications which are not accessible remotely. Thus, a challenge exists that enables browser- or network-based access to information of disparate formats. This lack of remote access impairs the ability to effectively use and otherwise disseminate information and data.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a healthcare management tool browser-based version of a client that enables clinicians, from remote locations, to review patient data retrieved from a healthcare data store. Particular embodiments are directed to network-based healthcare management tools that facilitate remote access to data of a variety of formats. Remote locations include, but are not limited to, from outside the hospital (e.g., at home, third party healthcare facility) or from inside the hospital but in an office or lab that does not have intranet access to the healthcare data store.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example block diagram of a system that facilitates secure transfer of healthcare data by way of a network such as the Internet in accordance with an aspect of the innovation.

FIG. 2 illustrates an alternative high level diagram that facilitates secure network-based access to health-related data in accordance with aspects of the innovation.

FIG. 3 illustrates an example system architecture diagram that facilitates network-based data access in accordance with aspects of the innovation.

FIG. 4 illustrates an example high level architecture diagram showing components and data flows between them in accordance with an aspect of the innovation.

FIG. 5 illustrates an example flow diagram of procedures that enable network-based access to health-related data in accordance with aspects of the innovation.

FIG. 6 illustrates an example login module in accordance with aspects of the innovation.

FIG. 7 illustrates an example grid view module in accordance with aspects of the innovation.

FIG. 8 illustrates an example component launch module in accordance with aspects of the innovation.

FIG. 9 illustrates an alternative architecture drawing that identifies data flow between components in accordance with aspects of the innovation.

FIG. 10 illustrates an example simple grid view in accordance with aspects of the innovation.

FIG. 11 illustrates an example of a standard grid view in accordance with aspects of the innovation.

FIG. 12 illustrates a text panel view in accordance with aspects of the innovation.

FIG. 13 illustrates an example image view in accordance with aspects of the innovation.

FIG. 14 illustrates an example image view in accordance with aspects of the innovation.

FIG. 15 illustrates an alternative system diagram that depicts network-based access in accordance with aspects of the innovation.

FIG. 16 illustrates a block diagram of a computer operable to execute the disclosed architecture.

FIG. 17 illustrates a schematic block diagram of an example computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component,” “module” and “system” are intended to refer to a computer-related entity, either hardware, a combination of hardware and software, software, or software in execution. For example, a module can be, but is not limited to being, a process running on a processor, a processor, an object, an executable, a thread of execution, a program, and/or a computer. By way of illustration, both an application running on a server and the server can be a component. One or more modules can reside within a process and/or thread of execution, and a module can be localized on one computer and/or distributed between two or more computers.

Remote (e.g., Web- or Internet-based) access to healthcare management tools and associated data is one of the key features of the innovation. As described herein, the innovation enables physicians to view patient data when they are outside the hospital. For example, healthcare data can be accessed via the Internet, intranet or other appropriate network connection. Unfortunately, in accordance with conventional solutions, referring physicians, who are not employed by the hospital, most often have no ability to access the hospital's intranet and computers. In order to do so, they have to obtain authority to view their patients' information by way of an internal data connection. Thus, the innovation provides systems and methodologies by which data can be remotely and network accessible.

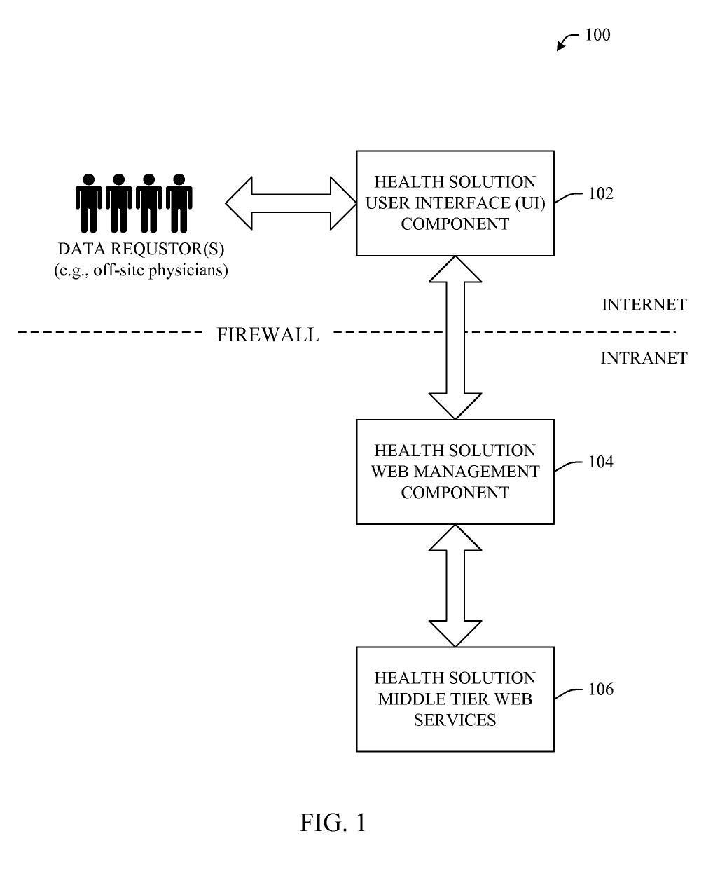

Referring initially to FIG. 1, a block diagram of a system 100 that facilitates remote healthcare data access is shown. It is to be understood that the system 100 is capable of accessing and rendering data of disparate formats by way of most any network connection (wired or wireless). Additionally, it is to be understood and appreciated that the features, functions and benefits can be employed using most any device including, but not limited to, desktop computers, laptop computers, smartphones, personal data assistants (PDAs), cell phones, or the like.

Generally, system 100 includes a health solution (HS) user interface (UI) component 102, an HS web management component 104 and an HS middle tier web services component 106. Essentially, data requestors can remotely access the HS middle tier web services 106 by way of the HS web management component 104, or more specifically, via the HS UI component 102.

One target audience for this innovation is physicians that are employed by a hospital who need (or otherwise desire) access to patient information from a location outside their hospital (or healthcare facility) as well as the affiliated physicians who refer patients to the hospital. It will be understood and appreciated that allowing access to data through the Web will increase the number of use cases that are supported by the system. This will increase customer satisfaction as it adds the functionality that is crucial in a physician's everyday workflow of patient care. This innovation increases reliable access to patient data, thus increasing the efficiency and potentially, safety of patient care.

As described above, there are many heterogeneous clinical systems in a hospital. The ability to retrieve data from the assorted systems and to display the information with a unified format in different Web browsers has not been solved by conventional clinical systems. Another challenge is to access the diverse clinical data and to transmit and provide a pleasant user experience under high latency and low bandwidth network environments. Yet another challenge is to secure clinical data over a network (e.g., Internet) environment. The subject innovation addresses these and other conditions.

Following are user scenarios which provide perspective to the functionality of the innovation. It is to be understood that these scenarios are provided merely to provide context and not to limit the scope of the innovation in any manner. In these scenarios a clinician, typically a physician, is remote (e.g., home, other office/facility outside the hospital LAN) and is connected to the web via the WAN (e.g., broadband and/or dial up modem) or WWAN. The clinician needs to access patient data for a variety of reasons such as, but not limited to, reference as part of clinical decision making during an external patient encounter, obtain quick access to data when paged about a patient emergency, etc. Following is a common remote access scenario:

An on-call physician covering for a group of specialists (e.g., cardiology—a heart specialist) is paged at home for a consult for a patient who has just been admitted to the hospital's inpatient ward with congestive heart failure (an inability of the heart to adequately pump blood resulting in fluid collecting in the lungs) from the Emergency Room. The physician is being paged because the nurse noticed a rapid and irregular pulse (beating of the heart) while she was collecting vital signs and had an EKG (electrocardiogram) performed which showed an irregular heart rhythm (beating of the heart).

After calling the nurse back and while speaking with her, the physician opens a browser window to log into the hospital portal (e.g., https://webamalga.myhospital.com). Depending on the security policy of the organization, the user might be required to use two-factor authentication or to establish a VPN (virtual private network) connection before being able to connect to the application.

Additional scenario: the physician receives an email with an encrypted or abbreviated link (should not expose the patient name or medical record number in clear text) that would take him directly to the specific patient once logged onto the Web-based system bypassing selecting potentially another view and/or searching for the specific patient.

Within a short time of opening the browser window (e.g., 10-15 seconds for the first screen after logging in and 2-3 seconds for any subsequent screen changes), the physician is presented with a list of patients (his default “remote” view) and then selects the specific patient. He is presented with a summary page of the most recent patient information: chief complaint, PMH (past medical history), medications, vital signs, EKG, imaging (radiology and document images), transcribed reports and lab results. The physician then clicks to access the related radiology images, and scanned documents from the emergency room to understand more about the patient's initial condition on presentation to the emergency room. The physician then uses the Web-based system to rapidly locate and review the old EKG and chest x-ray.

Based on the available information and ability to compare the current and old EKG's and the current and prior chest x-rays, he concludes that the patient is likely to be suffering from both congestive heart failure and a new onset atria fibrillation, a specific type of abnormality in electrical conduction within the heart and one of the causes of an ‘irregular heart beat’.

The physician also examines older lab results such as blood counts and clotting tests, a recent discharge summary from a previous visit to the hospital, and the list of home medications which were collected by the nurse in the triage department.

Within 3-4 minutes, because of the rapid remote access to the clinical information, the physician has been able to develop a diagnosis and probable treatment strategy, thereby allowing him to provide the nurse some preliminary medical orders over the telephone to start the therapy process before his 30 minute drive to the hospital to see the patient.

Essentially, in aspects, the innovation provides capabilities that enable hospital physicians to access healthcare data management tools and associated clinical data safely via Web browsers at most any time and most any place. In aspects, based on technology such as ASP.net technology, the solution can utilize a specialized Web Server to retrieve perspective clinical data. Through Web browsers, the innovation securely presents the data to users within the HS user interface (UI) 102.

In order to address the security of data, the innovation can provide read-only functionality and strictly limit the scope of the clinical data that can be viewed using base views and user-designed views to which the user account has access. In order to guarantee the performance of Web (or network) access to different clinical data, the innovation not only provides data cache and middle tier cluster at the server side, but also divides clinical data navigation into multi-pages at the client side as illustrated and described with reference to the figures that follow.

With continued reference to FIG. 1, system 100 facilitates secure transfer of healthcare data by way of a network such as the Internet. More particularly, FIG. 1 illustrates a workflow to setup a connection between the innovation's Web solution and existing desktop (local) system. In aspects, the system 100 illustrates a wholly pluggable add-on to a healthcare data management tool.

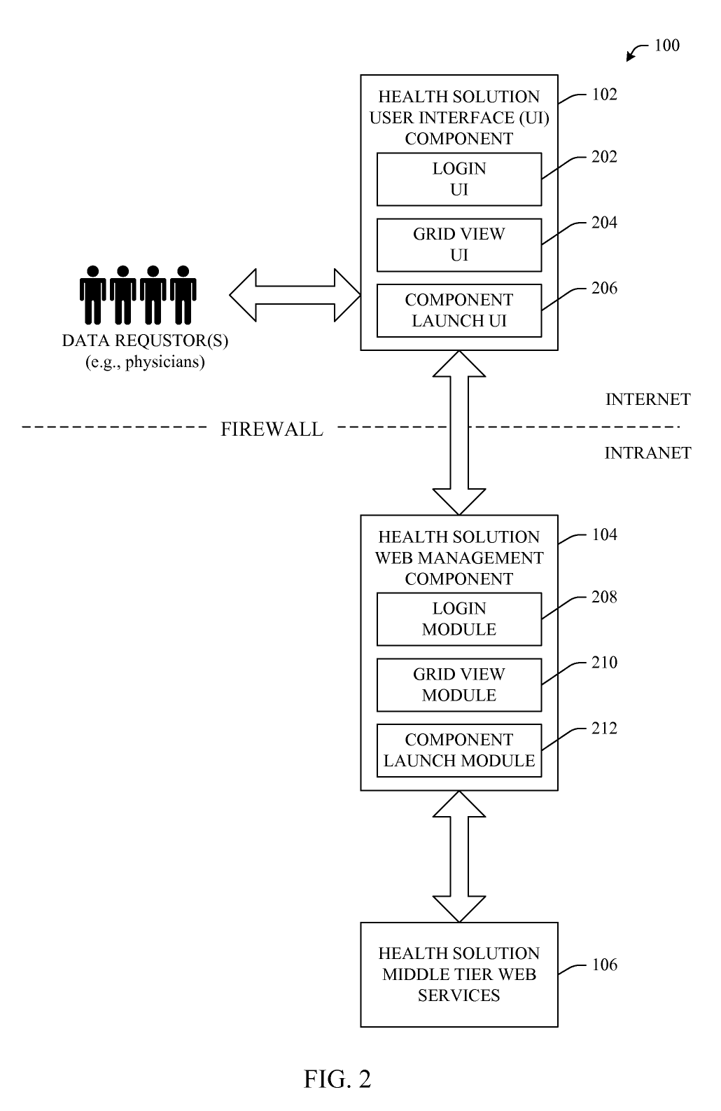

FIG. 2 illustrates an alternative block diagram of system 100. More particularly, FIG. 2 illustrates sub-components of each of the HS UI component 102 and the HS web management component 104. The sub-components (202, 204, 206) of the HS UI component 102 effectuate interaction between a user and the system 100 functional components (104, 106). Essentially, the sub-components (202, 204, 206) of the HS UI component 102 enables interface with the sub-modules (208, 210, 212 respectively) of the HS web management component 106.

For example, the login UI 202 enables a user to enter login credentials (e.g., username and password). Once entered, the associated login module 208 can attempt to validate the credential and thereafter make a decision regarding authentication and/or authorization in connection with middle tier applications. Similarly, the grid view UI 204 enables presentation of health related data. By way of the grid view UI 204, a requestor can sort, filter, select, etc. information. This information and data can be configured and rendered via the grid view module 210. Finally, the component launch UI 206 enables a user to choose from a variety of provided components by which data can be accessed and ultimately provided to the requester. Accordingly, once selected, the component launch module 212 is employed to launch or trigger the selected module.

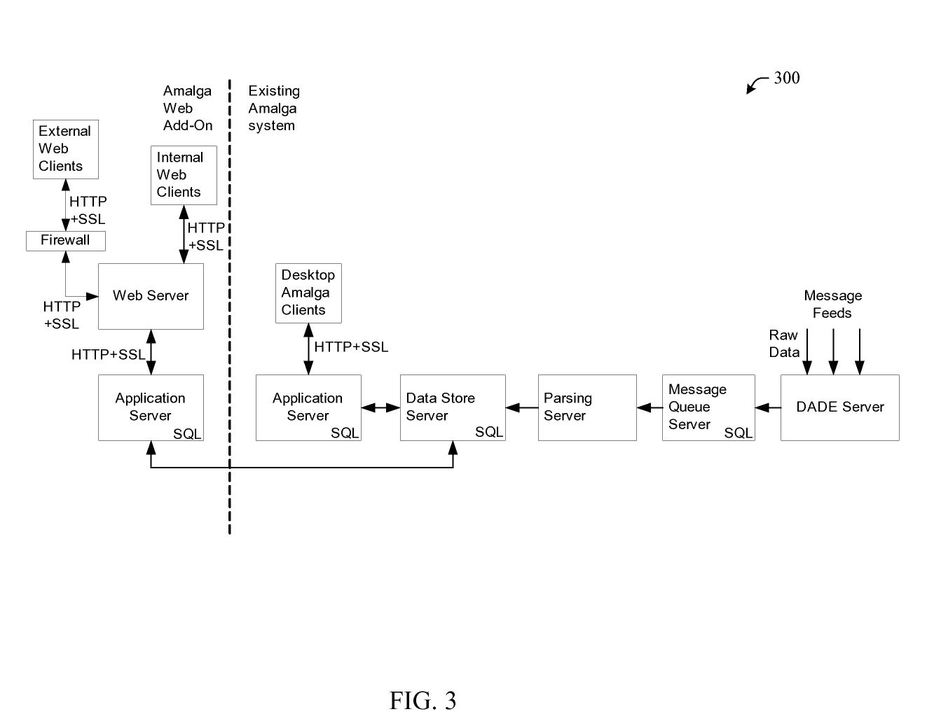

Referring now to FIG. 3, a block architectural diagram of a system 300 in accordance with aspects of the innovation is shown. As illustrated, the system 300 demonstrates that the innovation can be a wholly pluggable add-on to an existing HS data system. The web-based system can be enabled by adding a Web Server to an existing HS data system, as shown. FIG. 3 illustrates one production environment deployment architecture in accordance with the innovation. It is to be understood that other environments exist which are to be included within the scope of this disclosure and claims appended hereto.

As the architecture diagram shows, if desired, the web-based components can be removed from the existing HS data system by simply disconnecting the Web Server and its dedicated Application Server, without affecting the host HS system. In aspects, to access the web-based HS system of the innovation, a clinician (or requester) at a Web Client (as labeled in FIG. 3) can perform the following sequence of steps: 1) connect the client computer to a network (e.g., broadband or a dial-up modem from home or a wireless network within the hospital); 2) open a web browser application; and 3) enter the URL (uniform resource locator) of the hospital portal, for example, https://webamalga.myhospital.com. Depending on the security policy of the organization, the user might be required to use two-factor authentication or to establish a VPN (virtual private network) connection before being able to connect to the application. The clinician may need to access patient data for a variety of reasons, for example, to refer to the data as part of clinical decision making, to obtain quick access to data when paged about a patient emergency, etc.

In one example scenario, a physician may be able to use the clinical information retrieved by the system 300 from the HS data store to develop a diagnosis and probable treatment strategy in a matter of minutes when called at home about a patient emergency. The clinician can also provide a nurse some preliminary medical orders over the telephone to start the therapy process, and then start the 30 minute drive to the hospital to see the patient. It will be appreciated that this is but one example of the utility of the innovation.

The system 300 of FIG. 3 illustrates that a Web Server shown in the diagram may point to one Application Server or a cluster of Application Servers. It is to be understood and appreciated that reliability and performance can be enhanced by pointing to a cluster. Other example systems can be configured which do not have a dedicated Application Server—these alternative aspects are to be included within the scope of the disclosure and claims appended hereto.

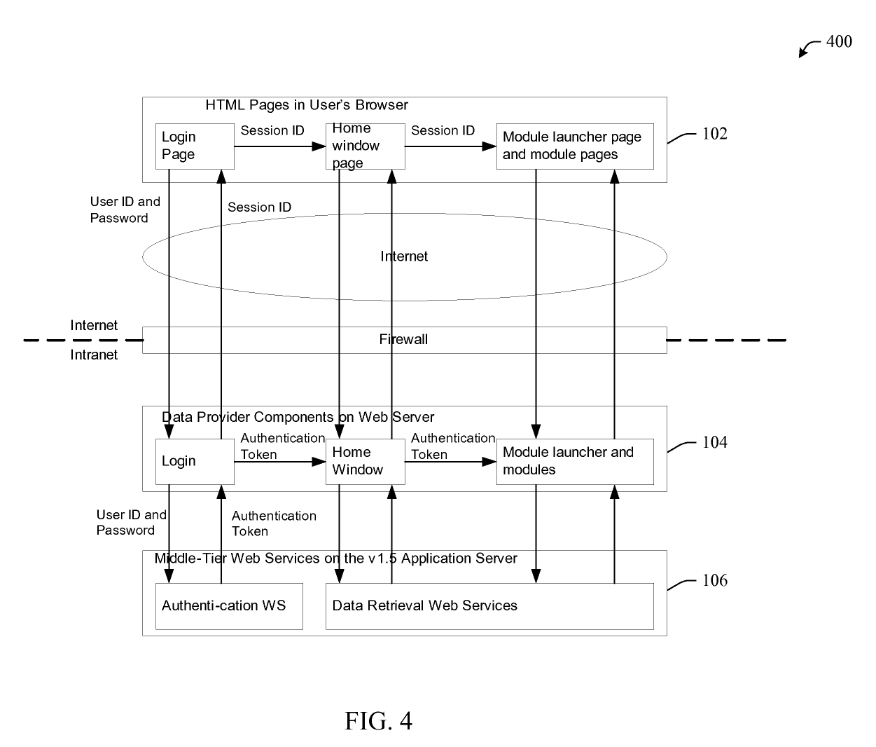

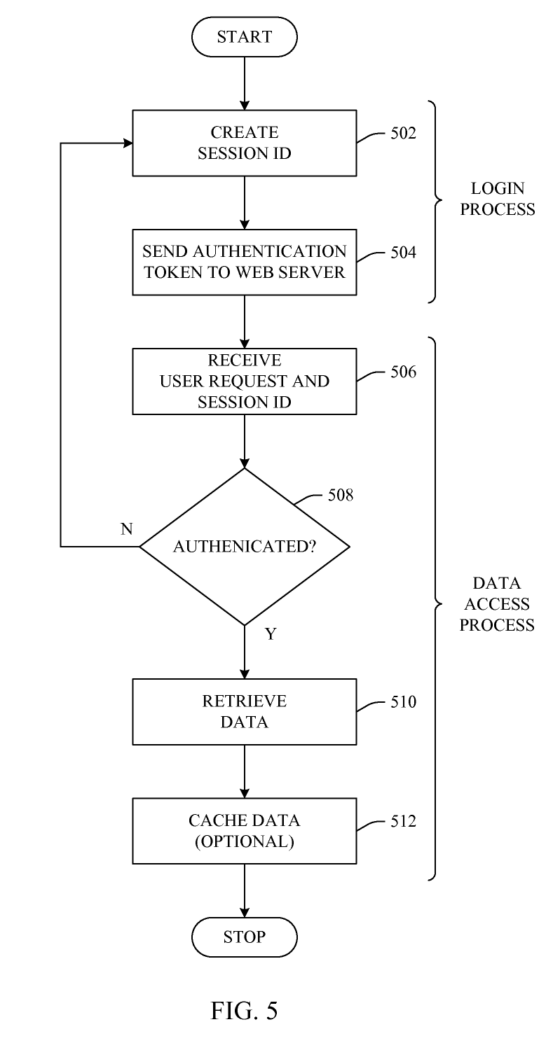

FIG. 4 illustrates an alternative architectural diagram of a system 400 in accordance with the innovation. Essentially, FIG. 4 illustrates data flow patterns between components and modules of the system 400. A process flow diagram of the example data flow is shown in FIG. 5. It is to be understood and appreciated that the portion of the methodology that defines a data access process shown in FIG. 5 can be recursive in operation. In other words, the processes shown in this figure correspond to a single data request in addition to login. Alternative process flows having multiple data accesses are to be included within the scope of this disclosure and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Referring to FIG. 5, in accordance with the data flow, at 502, a session ID (identification) is created or generated. In aspects, a session ID is created when user accesses the Login page with Web browser, as illustrated in FIG. 4. A user ID and password (or other credentials) inputted in this page are sent to the Login module in Web server and forwarded to the Authentication Web service running on the Application Server at 504.

After the Authentication Web Service validates the user ID and password, the service sends an authentication token back to the Web Server. This authentication token is stored in the session state on Web server and it corresponds to the client session ID.

At 506, for each time the user tries to access a page, the Web Client sends the session ID to the Web Server to identify the session to which the request belongs. Authentication is established at 508. For each data retrieval request, the Web Server data provider component sends the stored corresponding authentication token to the middle-tier web services on the Application Server that retrieve the data from the back-end Data Server at 510.

The middle-tier Application Server performs security checks, using the passed-in authentication token, before it acts on the data retrieval request. In order to improve the performance, some of the retrieved data can be cached at 512 on Web server to reduce the communication between Web server and Application server. Meanwhile, the innovation divides the data set into multi-pages to reduce transmission time and save the memory in the server cache. Unique GUIDs (globally unique identifiers) for data queries can also be cached on Web server. Thus, client browsers need only to send back indices to visit different data. Invalid indices are not allowed by Web server. This can restrict the user to access the data limited by base view and user view.

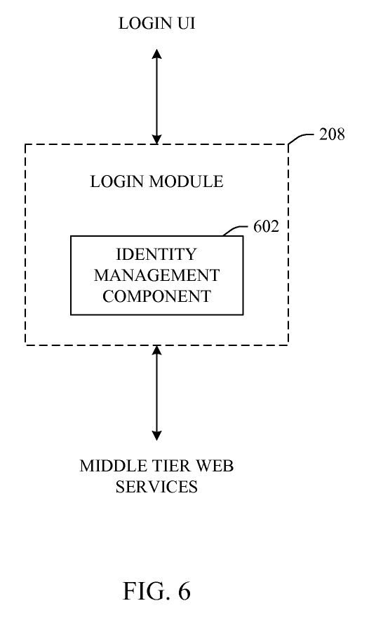

Turning now to FIG. 6, a block diagram of an example login module 208 is shown. As described above, each functional component such as a login module 208 is associated with a corresponding view component, for example, a login UI 202. Generally, the login module 208 can include an identity management component 602 that facilitates administration of user's credentials upon access to the system.

A Web user at an external Web Client can enter a user ID and password to log in to the system. This entry can be effected by way of the login UI 202 as shown in FIG. 2. Thereafter, the Web Server (or identity management component 602) passes the user ID and password to the Authentication Web Service running on the middle-tier Application Server and does not give the user read-only access to any data until the middle-tier Authentication Web Service validates the user credentials and passes an authentication token back to the Web Server.

For the rest of that user session, each of the data provider components (208, 210, 212) running on the Web Server require the authentication token to be passed along with any data retrieval requests before that component will carry out that data retrieval request. After a period of non-use, the Web application automatically closes itself and clears the cache of any remnants of data. It is to be understood that a period of non-use will cause timeout of the system. The application redirects to the Login page or login UI 202 whereby credentials can be re-entered. The automatic timeout value can be set user-defined in the system configuration.

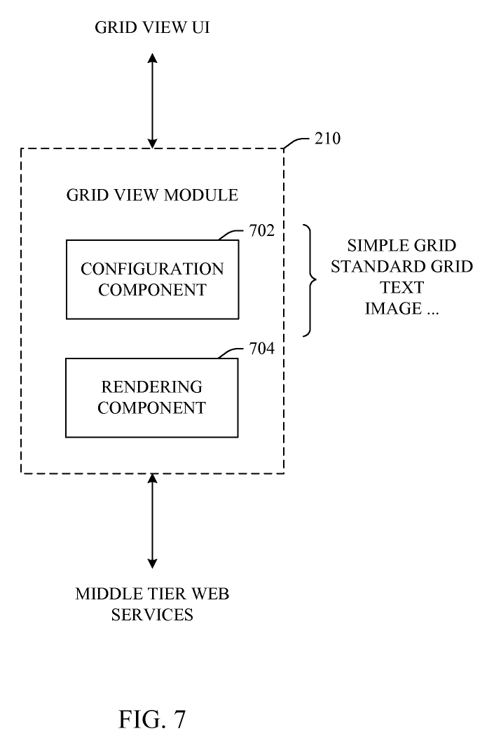

Turning now to FIG. 7, an example block diagram of a grid view module 210 is shown. Generally, the grid view module 210 includes a configuration component 702 and a rendering component 704 which together facilitate presentation of data to a user. Presentation is accomplished by way of the grid view UI 204.

The grid view or data grid is one of the most important parts of the system. In operation, the configuration component 702 and rendering component 704 enable data to be viewed, sorted, filtered or the like as desired or appropriate. The following examples are provided to add perspective the functionality of the data grid module 210. It is to be understood that these functionalities are provided to describe specific embodiments and are not intended to limit the innovation in any manner.

In a first aspect, a patient view can be provided by the system. A patient view can show a patient data set which is defined by the administrator or the end user. If the physician has the access authority for a desktop version of the system, s/he can define her/his own user view and default view with desktop client. In the web-based version of the innovation, the user can select different user views to display data in data grid or grid view UI 204. Here, the configuration component 702 together with the rendering component 704 can be employed to enable desired or selected views.

The grid view module 210 can also enable “find” and “unfind” features. Here, a user will be able to find the records of interest based upon specified parameters in a find panel. It will be understood that, the find panel can be presented in the corresponding grid view UI 204. Example screen shots are shown in the figures that follow.

While certain ways of displaying information to users are shown and described with respect to certain figures as screenshots, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

The grid view module 208 (by way of its sub-components 702, 704) can also sort records based upon most any defined sort criteria. Similarly, information can be filtered and zoomed, for example, access all records related to a specific record (e.g., social security number (SSN)). Additionally, records can be limited based upon a date range, or most any other definable criteria. Patient data can also be located pertaining to a selected cohort category. Yet another function of the grid view module 208 is to enable a user to access information components via the component launch module 212.

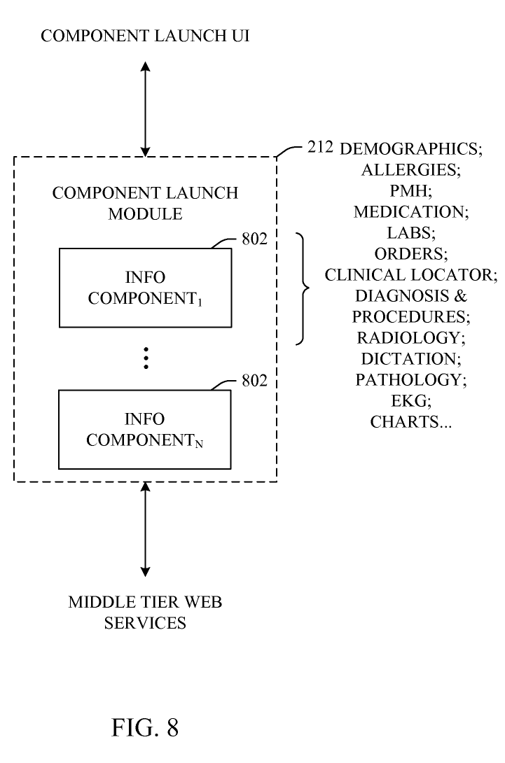

FIG. 8 illustrates an example component launch module 212 in accordance with aspects of the innovation. As shown, the module 212 can include 1 to N info components 802, where N is an integer. The component launch module 212 is effectively a container which holds info components or modules 802. The component launcher 212 in accordance with the innovation supports a subset of functionalities of the corresponding desktop HS module. In one aspect, there are thirteen info components 802 included in web info components display (component launch UI 206) detailed patient information to users.

The thirteen example components 802 include demographics, allergies, past medical history (PMH), medication, labs, orders, clinical locator, diagnosis & procedures, radiology, dictation, pathology, electrocardiogram (EKG) and charts. Each of these components 802 are described below.

The first example info component 802 that displays information to a user is a demographics component. This component is a simple grid that shows some “Demographics” information in different pages. Printing the content in specified format will be provided for this module.

An allergies component is also a standard grid presentation of information. Here, the standard grid shows information of “Allergy” which can be sorted by clicking on each column header. Other controls in this grid can include an all visits option, a “Reset Sort Order” button, and a “Format” button, among others. The “Format” button can invoke a popup dialog to set row height, text font, foreground color and background color of title area and data area. “Print” and “Print Preview” are also supported.

A past medical history or PMH has the same operation experience as allergies. Here, a standard grid shows information of “Past Medical History” which can be sorted by clicking on each column header. Other controls in this grid can include an all visits option, a “Reset Sort Order” button, and a “Format” button, among others. The “Format” button can invoke a popup dialog to set row height, text font, foreground color and background color of title area and data area. “Print” and “Print Preview” are also supported.

Still further, a medication module has similar operation experience to allergies and PMH. A standard grid shows information of “Medication” which can be sorted by clicking on each column header. Controls can include “Selected Visit” and “All Visits” radio buttons. This is a main difference from Allergies and PMH module. Other controls in this grid can include an all visits option, a “Reset Sort Order” button, and a “Format” button, among others. The “Format” button can invoke a popup dialog to set row height, text font, foreground color and background color of title area and data area. “Print” and “Print Preview” are also supported.

A labs module is considered one of the most complex component module. There are many pages in this module. The number of pages depends on the configuration of this module. The Labs—Summary page has similar operation experience with Medication while other pages have their own special tables to show very detailed lab results. In the Summary page, the module supports “Selected Visit” and “All visits” radio button. A “Details” button to show detail information is supported. For example, a popup “Lab Details” dialog shows detail information and supports “Graph,” “Merge,” and “Transpose.”

A “Format” button invokes a popup dialog to set row height, text font, foreground and background color of title area and data area. Additionally, “Print” and “Print Preview” can also be supported. The All page shows all labs results while other pages can display classified labs results in separate pages. These pages have the same operation experience compared with each other. For example, there are multiple data tables in each page and each table has a table caption row to show brief information including date/time, lab categories, etc.

In the example, the table body contains kinds of detailed lab results and a tail will be attached to the table to indicate there are no more data lines. “Selected Visit” and “All visits” radio buttons can be employed as well as a “Details” button to show detail information. A pop-up “Lab Details” dialog shows detail information for a specific lab item and it also supports “Graph,” “Merge,” and “Transpose” to show the data in different style or in different view such as graph view.

A “Format” button can be provided to invoke a popup dialog to set row height, text font, foreground and background color of title area and data area. Consistent with other modules, the labs module also supports “Print” and Print Preview” for pages within the module.

The Orders module has similar operation experience to Medication. There are multiple pages that display different kinds of detailed information in the same way. Multiple standard grids show information which can be sorted by clicking on each column header. The view supports a “Selected Visit,” “All visits” and “Reset Sort Order” radio buttons. A “Format” button invokes a popup dialog to set row height, text font, foreground color and background color of title area and data area. “Print” and “Print Preview” are also supported.

The clinical locator module has similar operation experience to Orders. There can be multiple pages that display different kinds of detailed history information in the same way. Multiple standard grids show information which can be sorted by clicking on each column header. The view supports “Selected Visit” and “Reset Sort Order” buttons. A “Format” button invokes a popup dialog to set row height, text font, foreground color and background color of title area and data area.

The “Diagnosis & Procedures” module has similar operation experience to Orders. They are two pages displaying detailed Diagnosis and Procedures information in the same way. Multiple standard grids show information which can be sorted by clicking each column header. “Selected Visit,” “All visits” and “Reset Sort Order” buttons are supported. A “Format” button invokes a popup dialog to set row height, text font, foreground color and background color of title area and data area.

Turning now to the radiology readings info module, there are multiple pages in these modules displaying different kinds of report style text. A control having similar functionalities as FlowDocument control in WPF can be implemented and employed in this module for operations on data content. Similar to the other modules described above, “Currently Selected Visit” and “All Visits” are supported. A “Find” button to find text in the content and a “Copy” button to copy full content into clipboard can be provided with the addition of zoom content.

The Dictations module has the same operation experience as the Radiology Readings module described above. There are multiple pages displaying different kinds of report style text. A “FlowDocument” control can be employed by this module to provide operations on data content. Similar to the other modules described above, “Currently Selected Visit” and “All Visits” are supported. A “Find” button to find text in the content and a “Copy” button to copy full content into clipboard can be provided with the addition of zoom content.

The pathology module has the same operation experience as Radiology Readings. There can be multiple pages displaying different kinds of report style text. “FlowDocument” control will be employed by this module to provide operations on data content. Similar to the other modules described above, “Currently Selected Visit” and “All Visits” are supported. A “Find” button to find text in the content and a “Copy” button to copy full content into clipboard can be provided with the addition of zoom content.

There are two pages/layers in the EKG (electrocardiogram) module. The first page is a category view and the second popup one is a full detailed view. In the category view, there are a visit list in left and a thumbnail image list in right. The visit list is distinguished by different visit dates and every list item contains two columns including visit date and study count for corresponding visit item. The thumbnail image list shows thumbnail images which belong to the current selected visit study. Double clicking on the thumbnail image causes the detailed view to be shown.

In the detailed image viewer, there is a thumbnail list in the left which shows all thumbnail images for EKG images in current study. Center area of this viewer is the image area which supports zooming operation. There are some panels which display different kinds of image information surrounding this image area. The innovation implements the basic zoom function for this module. Measurement, image contrast and intensity adjusting, and other unmentioned functionalities are also defined. Both pages contain “All Visits” and “Selected Visit” radio buttons.

Scanned Charts module is in some degree similar to EKG viewer module and supports less functionality than the later one. There are two pages/layers in this module. The first page is a category view and the second popup one is a full detailed view. The category view contains two parts, a tree list is located in left and a thumbnail list occupies the right part. The tree list categorizes all scanned documents according to visit dates and document types. The thumbnail image list shows thumbnail images which belong to the current selected node in the tree list. Double clicking (or otherwise selecting) on the thumbnail image causes the detailed view to be shown.

In the detailed scanned image viewer, there is also a thumbnail list in left which shows all thumbnail images for scanned document images within current selected type. Right part of this viewer is an image view control which supports zoom operation. The innovation implements the basic zoom function, flipping, reversing, rotating, and navigation for this module. Image contrast and intensity adjusting, and other unmentioned functionalities are also defined. It is to be understood that printing and print view capabilities can be employed in connection the aforementioned info modules 802.

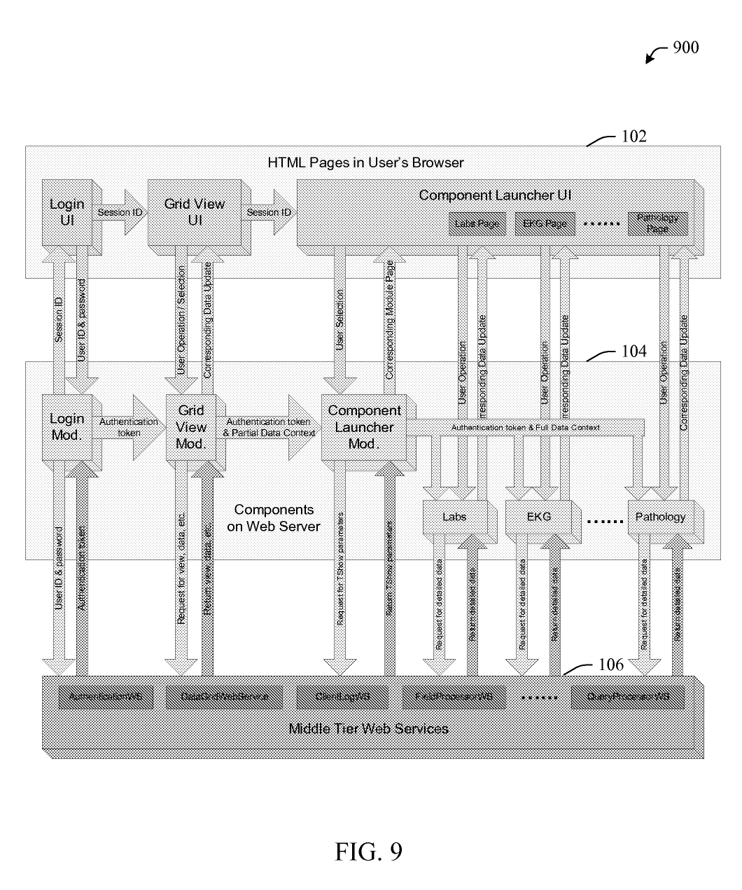

Referring now to FIG. 9, an alternative block diagram of a system 900 in accordance to aspects of the innovation is shown. On a high level, the system 900 will follow a layered architecture. The client could be separated into two layers, one layer (HS web management component 104) includes most business logic in server side and another layer (HS UI component 102) includes HTML pages and some JavaScript in user's browser. As shown in FIG. 9, both middle tier server and database server 106 are hidden behind the Web server 104.

The functionality of Web applications or modules exists in processing user input, forwarding the request along the chain of components which dynamically generate appropriate data for the application to be able to present specific results to the user. The Web server modules (208, 210, 212), e.g., written in ASP .NET and AJAX, would communicate with the middle tier server 106, e.g., through ASMX web services, to retrieve all kinds of patient data and application configuration from backend database. These modules (208, 210, 212) will render data retrieved into HTML pages (202, 204, 206) embedding with some JavaScript code. Finally, the thin client would run in a browser and show the preformatted HTML pages to users.

The UIs of the DataGrid or HS UI component 102 will be launched after login (and authentication as appropriate). The server layer module or HS web management component 104 would then contact the HS Middle Tier web services server 106 to load data for the default view of the user logged in. The user would also be able to change the view by choosing one of the available base views or user views in the View Manager or grid view UI 204. This would trigger corresponding server module to call the web service APIs with the selected base view ID parameters to get the data.

The DataGrid components (202, 204, 206) include several smaller logical entities. The most significant of which is the spreadsheet like DataGrid control (or grid view UI 204) itself which would display the patient data. For each record the DataGrid will be bound to a data object which would contain the actual data and would behave as the basis of the context that will pass to different modules through the component launcher 212. The data being displayed depends upon which base/user views are selected; sorting conditions, filters, and data ranges etc. which can all be set through invoking dialogues/windows from the grid display page or grid view UI 204.

On a very high (component) level, the Data Grid client component 102 corresponds with other component in the following fashion. It takes the Authentication token (and other authentication information) set up in the login component 208, requests the patient data according to the conditions specified, finally once a patient is selected for viewing detailed information, passes the context to the Component Launcher 212 to enable it to launch components (802). This flow is visually depicted in FIG. 9.

As illustrated, components are divided into two parts, View (102) and Data Provider (104). The View part provides general UI control such as main frame and UI controls; it also supports some simple functions such as sort. The View part also provides special UI control for special function such as detail button in Labs module. Data Provider part provides data which will be filled in UI controls. The system locates and identifies the parameter for retrieving data from Middle Tier server 106.

The Data Provider 104 can directly call Middle Tier 106 web services to retrieve data. These web services include, but are not limited to, QueryProcessor, ClientLog, etc. Parameters transferred into these modules include Authentication token and data context. The Authentication token is generated at Login and data context will be constructed in the Grid component.

As described above, in one aspect, there are totally thirteen modules inside Component Launcher 212. According to UI controls being used to display data, all these thirteen modules can be classified into four types, 1) simple grid in Demographics; 2) standard grid in Allergies, PMH, Medication, Orders, Clinical Locator and Diagnosis & Procedures module; 3) text panel in Radiology Readings, Dictations and Pathology and 4) image viewer in EKG and Scanned Charts module. Labs will use a combination of simple grid and standard grid.

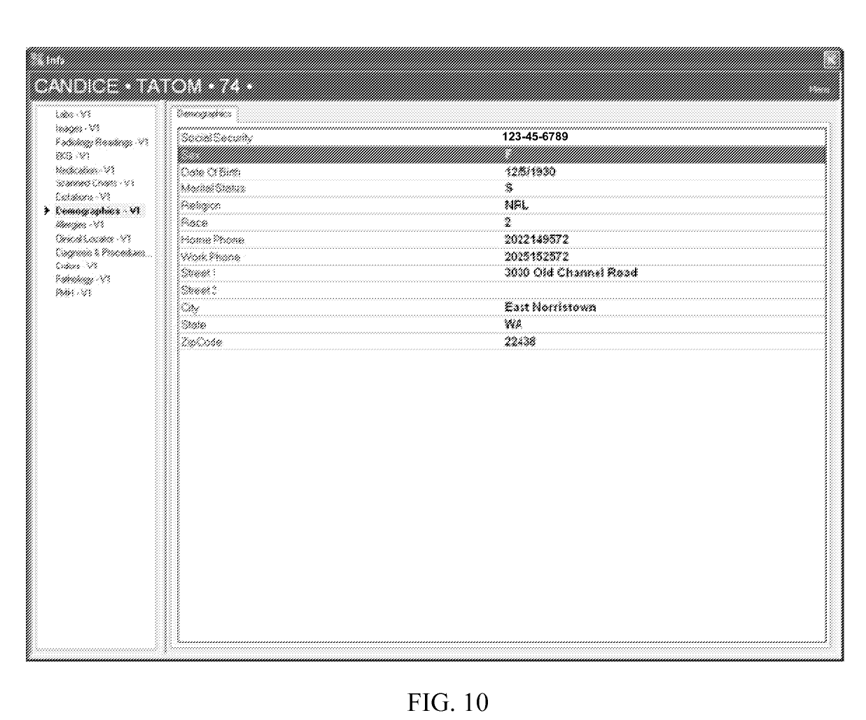

As shown in the example of FIG. 10, a simple grid includes a list for all modules' names in left and a panel container in right part. Selection of the module name in the left list will cause the main frame loading up corresponding module into right panel.

The example screenshot of FIG. 10 illustrates a simple grid depicting data in table style. This control has no column headers, does not support column resizing and any other user customization. It is only used in Demographics module. The Grid View control which is available in ASP.NET has enough functionality to implement this functionality.

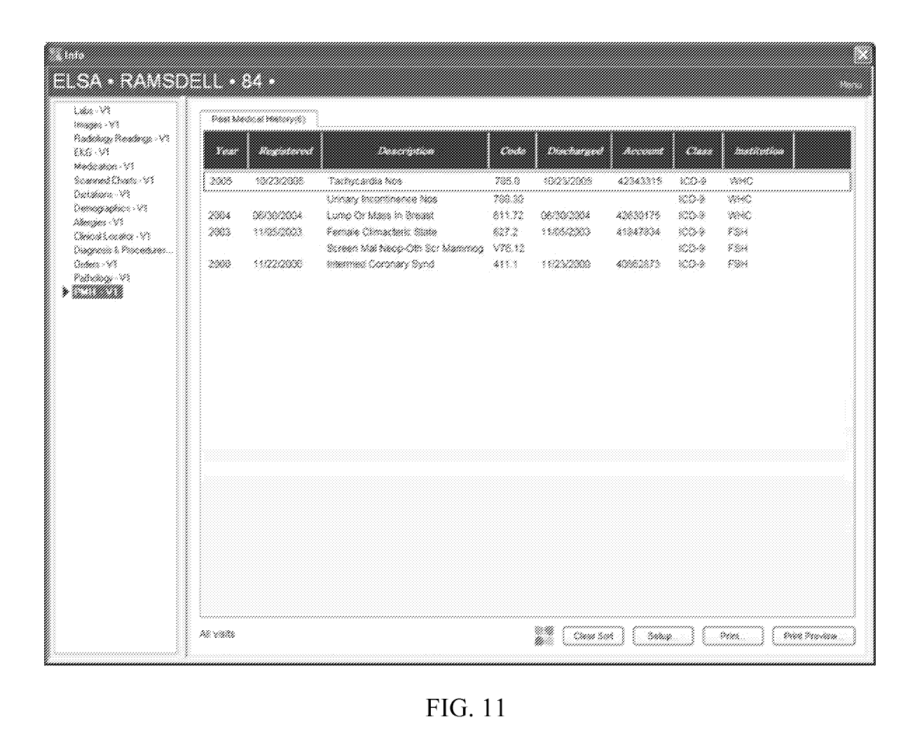

An example screen shot of a standard grid is illustrated in FIG. 11. Similar to the page view of FIG. 10, this control also displays data in table style. Compared to simple grid, standard grid has column headers. Clicking on (or otherwise selecting) a column header will cause the data to be sorted ascending or descending respect to that column. This control also supports user customization such as row height, font, background color, foreground color, etc. In aspects, this view is utilized in Allergies, PMH, Medication, Labs, Orders, Clinical Locator and Diagnosis & Procedures.

This kind of modules generally provide a “Clear Sort” button to restore data order and a “Setup” button to invoke a popup dialog to customize fonts and colors. The modules also provide Print and Print Preview functionalities. In some of these modules, there can be multiple tabs where each tab contains a standard grid to display data.

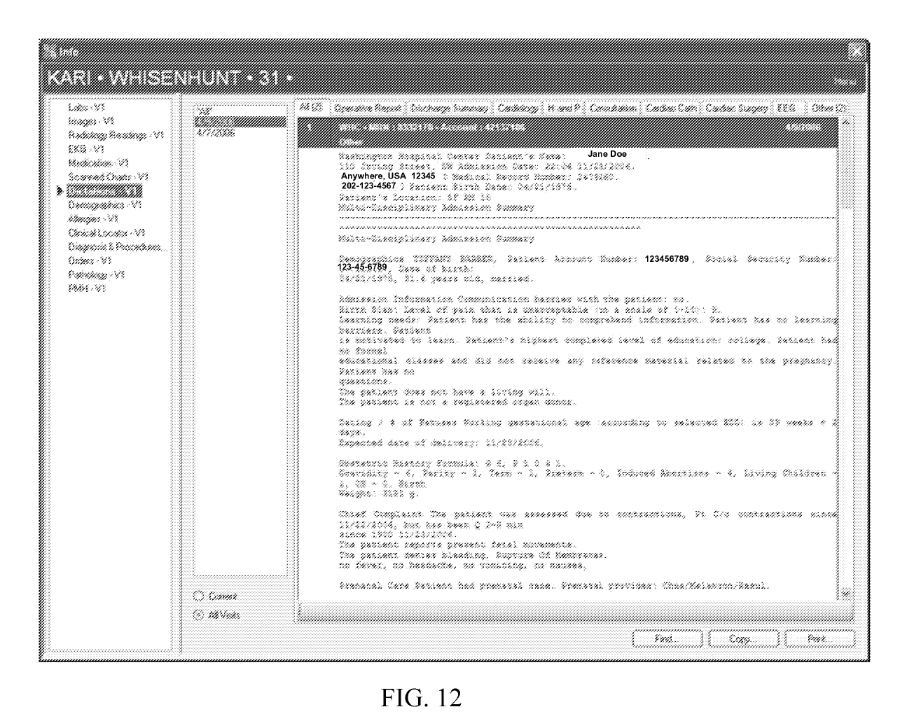

An example text panel is shown in FIG. 12. The main control here is a report style text container which is called FlowDocument in WPF. Formatted text will be displayed inside this control. This kind of module includes Radiology Readings, Dictations and Pathology. It is to be understood that this type of module supports find, copy, etc.

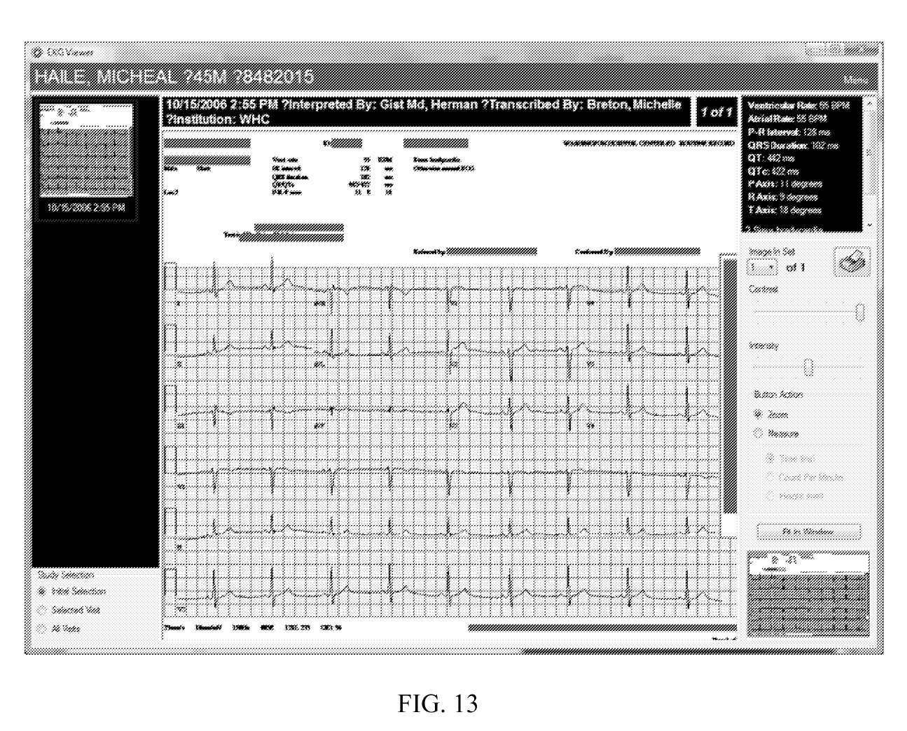

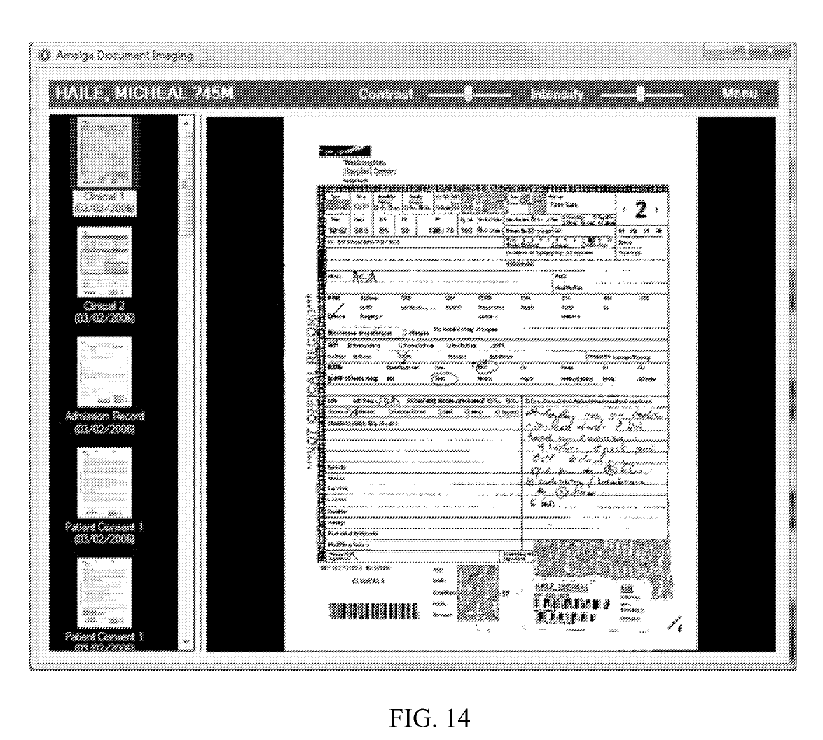

Finally, FIGS. 13 and 14 illustrate example image view controls, e.g., for EKG and Scanned Charts module. Looking at the central part of following two figures, this image view control supports zooming operation. In one aspect, after user pressing down mouse button, dragging the mouse to construct a rectangle, and then releasing mouse button (all operations should be done over the image), the content inside the rectangle will be stretched and displayed in the whole view control client area (with some adjusting on width or height). If user right clicks the mouse, zoom ratio will be restored to fit the image to the view control client area.

Actually, there is another common control in both EKG and Scanned Charts module. It is the thumbnail image list. This control supports simple selecting functionality and will be implemented with Grid View or other similar controls in ASP.NET. In the EKG viewer, the innovation will provide thumbnail image control in the right-bottom corner of the display. Some panels with detailed image information will be put surrounding the image view control in EKG module. The innovation will also provide other functions such as flipping, reversing and rotating for Scanned Charts module. In the mentioned two modules, there are also some other functionalities such as image contrast and intensity adjusting, printing which are enabled by the innovation.

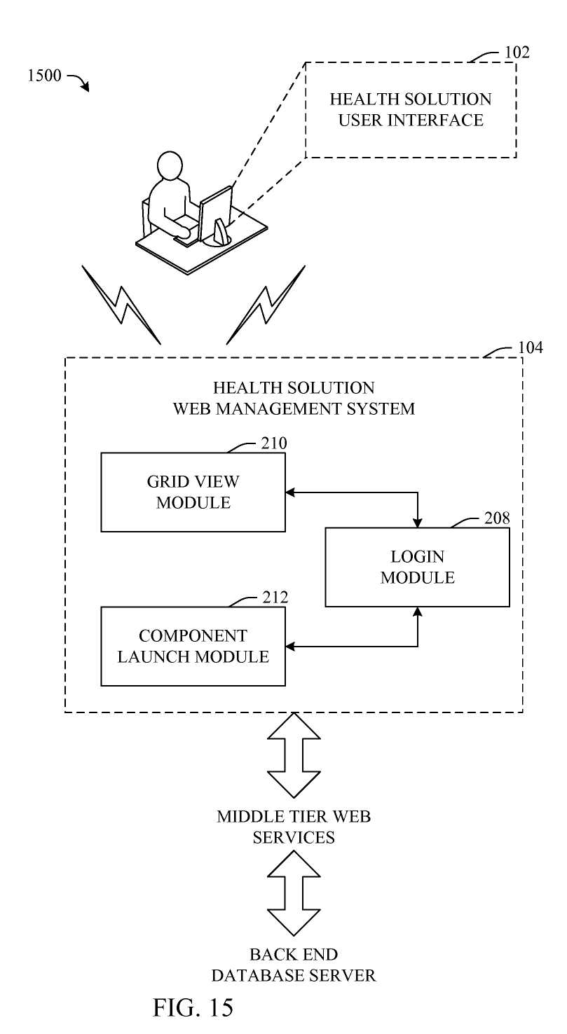

Referring now to FIG. 15, an alternative block diagram of a system 1500 is shown in accordance with aspects of the innovation. Essentially, FIG. 15 illustrates yet another view of a user securely accessing health-related data by way of middle tier web services. As shown, a user can employ HS UIs 102 to interact with the system. For instance, the UIs can be employed to enter information such as user credentials, data requests, patient names, presentation preferences (e.g., sort, filter . . . ). Additionally, the UIs can be employed to present health-related information to a user as shown in the example above-identified screen shots.

The security aspects of the innovation can be divided into primarily multiple categories including user authentication, security while transferring data over the internet and access policy. In aspects, forms authentication can be utilized on the Web server for all Web pages. If user accesses a specified Web page without system login, s/he will be redirected to the login page to input her/his user ID and password to set up the connection/session between Web browser and Web server. As described supra, this login process is enabled by way of the login module 208 together with associated login UIs and middle tier web services.

After user inputs her/his user ID and password, the Web server will use the Middle Tier Authentication Web service to authenticate whether the user ID is valid and the password is matched to the user ID. The generated Authentication Token will be kept in the session. All incoming Web service calls from Web server to Middle Tier for retrieving user configuration and patient data will utilize this token.

Secure Socket Layer (SSL) can be used to transfer data securely between Web browser (HS UI 102) and Web Server (HS web management component 104). It will be appreciated that SSL has become preferred in many e-commerce environments where e-payments and other confidential data need conformation with the confidentiality, Integrity and Authentication (CIA) model as they flow over the insecure public Internet. While SSL is employed in this aspect, it is to be understood that other protocols can be employed to secure transmissions without departing from the spirit and/or scope of the innovation.

For Web services in Middle Tier, it is understood that attackers can use the same hacking techniques as they use against a standard Web application. A difference is that they use XML payloads in HTTP POST requests. The malicious payload is embedded in the XML format. For at least this reason, the connection between Middle Tier server and backend database server can also also based on SSL (or other protocol) to avoid being hijacked by attackers and leaking sensitive data on the intranet or network.

It is to be understood that the system 1500 can be configured to provide read-only functionalities. In other words, the system 100 will not permit a user to modify any patient data or write any patient data back to the backend database. All data that the user can find is limited by her/his preset base view and user views. All provided operations such find, zoom should follow this access policy and never violate it.

Web based access to health-related data is one of the key features of the system 1500. As stated above, physicians desire an alternative solution for them to view patient data when they are outside a hospital. Referring physicians, who are not employed by the hospital, have no any chance to access the hospital's intranet and computers even though they have authority to view their patients' information. Thus, the web-based solution of the innovation would be very helpful to address this situation. One target audience for this innovation is physicians that are employed by the hospital and need access to patient information from a location outside the hospital as well as the affiliated physicians who refer patients to the hospital.

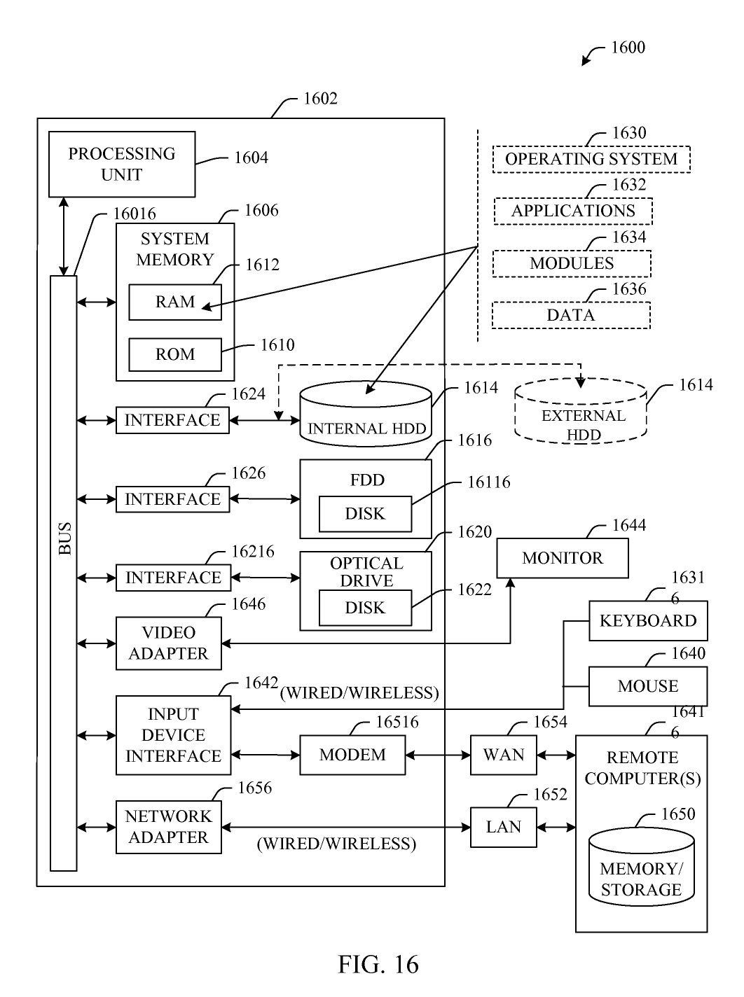

Referring now to FIG. 16, there is illustrated a block diagram of a computer operable to execute the disclosed architecture. In order to provide additional context for various aspects of the subject innovation, FIG. 16 and the following discussion are intended to provide a brief, general description of a suitable computing environment 1600 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 16, the exemplary environment 1600 for implementing various aspects of the innovation includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures may also be employed as the processing unit 1604.

The system bus 1608 can be any of several types of bus structure that may further interconnect to a memory bus (with or without a memory controller), a peripheral bus, and a local bus using any of a variety of commercially available bus architectures. The system memory 1606 includes read-only memory (ROM) 1610 and random access memory (RAM) 1612. A basic input/output system (BIOS) is stored in a non-volatile memory 1610 such as ROM, EPROM, EEPROM, which BIOS contains the basic routines that help to transfer information between elements within the computer 1602, such as during start-up. The RAM 1612 can also include a high-speed RAM such as static RAM for caching data.

The computer 1602 further includes an internal hard disk drive (HDD) 1614 (e.g., EIDE, SATA), which internal hard disk drive 1614 may also be configured for external use in a suitable chassis (not shown), a magnetic floppy disk drive (FDD) 1616, (e.g., to read from or write to a removable diskette 1618) and an optical disk drive 1620, (e.g., reading a CD-ROM disk 1622 or, to read from or write to other high capacity optical media such as the DVD). The hard disk drive 1614, magnetic disk drive 1616 and optical disk drive 1620 can be connected to the system bus 1608 by a hard disk drive interface 1624, a magnetic disk drive interface 1626 and an optical drive interface 1628, respectively. The interface 1624 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. It is appreciated that the innovation can be implemented with various commercially available operating systems or combinations of operating systems.

A user can enter commands and information into the computer 1602 through one or more wired/wireless input devices, e.g., a keyboard 1638 and a pointing device, such as a mouse 1640. Other input devices (not shown) may include a microphone, an IR remote control, a joystick, a game pad, a stylus pen, touch screen, or the like. These and other input devices are often connected to the processing unit 1604 through an input device interface 1642 that is coupled to the system bus 1608, but can be connected by other interfaces, such as a parallel port, an IEEE 1394 serial port, a game port, a USB port, an IR interface, etc.

A monitor 1644 or other type of display device is also connected to the system bus 1608 via an interface, such as a video adapter 1646. In addition to the monitor 1644, a computer typically includes other peripheral output devices (not shown), such as speakers, printers, etc.

The computer 1602 may operate in a networked environment using logical connections via wired and/or wireless communications to one or more remote computers, such as a remote computer(s) 1648. The remote computer(s) 1648 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1650 is illustrated. The logical connections depicted include wired/wireless connectivity to a local area network (LAN) 1652 and/or larger networks, e.g., a wide area network (WAN) 1654. Such LAN and WAN networking environments are commonplace in offices and companies, and facilitate enterprise-wide computer networks, such as intranets, all of which may connect to a global communications network, e.g., the Internet.

When used in a LAN networking environment, the computer 1602 is connected to the local network 1652 through a wired and/or wireless communication network interface or adapter 1656. The adapter 1656 may facilitate wired or wireless communication to the LAN 1652, which may also include a wireless access point disposed thereon for communicating with the wireless adapter 1656.

When used in a WAN networking environment, the computer 1602 can include a modem 1658, or is connected to a communications server on the WAN 1654, or has other means for establishing communications over the WAN 1654, such as by way of the Internet. The modem 1658, which can be internal or external and a wired or wireless device, is connected to the system bus 1608 via the serial port interface 1642. In a networked environment, program modules depicted relative to the computer 1602, or portions thereof, can be stored in the remote memory/storage device 1650. It will be appreciated that the network connections shown are exemplary and other means of establishing a communications link between the computers can be used.

The computer 1602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

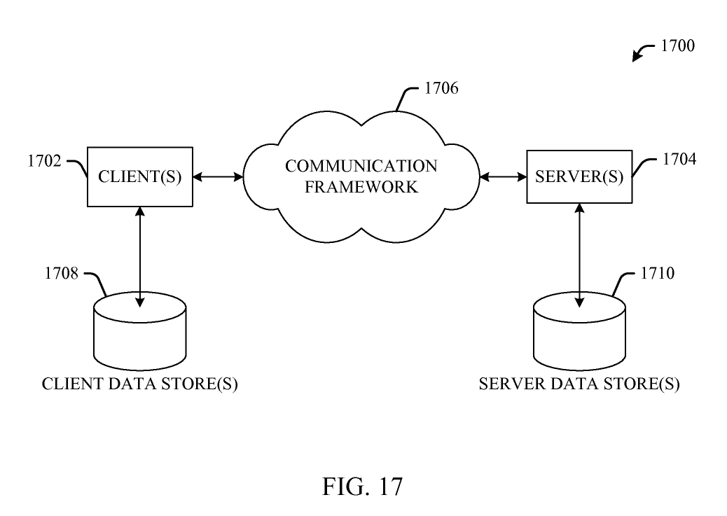

Referring now to FIG. 17, there is illustrated a schematic block diagram of an exemplary computing environment 1700 in accordance with the subject innovation. The system 1700 includes one or more client(s) 1702. The client(s) 1702 can be hardware and/or software (e.g., threads, processes, computing devices). The client(s) 1702 can house cookie(s) and/or associated contextual information by employing the innovation, for example.

The system 1700 also includes one or more server(s) 1704. The server(s) 1704 can also be hardware and/or software (e.g., threads, processes, computing devices). The servers 1704 can house threads to perform transformations by employing the innovation, for example. One possible communication between a client 1702 and a server 1704 can be in the form of a data packet adapted to be transmitted between two or more computer processes. The data packet may include a cookie and/or associated contextual information, for example. The system 1700 includes a communication framework 1706 (e.g., a global communication network such as the Internet) that can be employed to facilitate communications between the client(s) 1702 and the server(s) 1704.

Communications can be facilitated via a wired (including optical fiber) and/or wireless technology. The client(s) 1702 are operatively connected to one or more client data store(s) 1708 that can be employed to store information local to the client(s) 1702 (e.g., cookie(s) and/or associated contextual information). Similarly, the server(s) 1704 are operatively connected to one or more server data store(s) 1710 that can be employed to store information local to the servers 1704.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates remote data access, comprising:
a pluggable health solution (HS) user interface (UI) component that enables remote access of healthcare data of differing format; and
an HS web management component that communicates with the pluggable HS UI and accesses healthcare data from a backend source.

2. The system of claim 1, wherein the pluggable HS UI component facilitates the remote access via an application server and a web server.

3. The system of claim 1, wherein the HS UI component comprises:
a login UI component that accepts user credentials;
a grid view UI component that presents the healthcare data; and
a component launch UI that enables a user to select a type of information desired.

4. The system of claim 3, further comprising a login module that accepts credential information from the login UI and facilitates authentication via a middle tier Web service.

5. The system of claim 4, further comprising an identity management component that defines credential information related to the authentication.

6. The system of claim 3, further comprising a grid view module that facilitates presentation of the healthcare data via the grid view UI.

7. The system of claim 6, further comprising:
a configuration component that arranges the healthcare data into at least one of a simple, standard, text or image view; and
a rendering component that facilitates presentation via the grid view UI.

8. The system of claim 3, further comprising a component launch module that facilitates selection from a plurality of info components, wherein the info components define context of the healthcare data.

9. The system of claim 8, wherein the plurality of info components include at least one of a demographics component, an allergies component, a past medical history (PMH) component, a medication component, a labs component, an orders component, a clinical locator component, a diagnosis & procedures component; a radiology component, a dictation component, a pathology component, an electrocardiogram (EKG) component or a charts component.

10. A computer-implemented method of remotely accessing data via a healthcare data management tool, comprising:
creating a session ID when a user accesses a login page within a web browser;
authenticating the user;
processing a request from the user for healthcare data of a plurality of disparate formats; and
providing the requested healthcare data to the authenticated user via the web browser.

11. The method of claim 10, further comprising storing the session ID for subsequent data requests.

12. The method of claim 10, further comprising caching a portion of the requested healthcare data.

13. The method of claim 10, further comprising sending an authentication token to a web server, wherein the web server associates the authentication token with the session ID.

14. The method of claim 10, further comprising configuring the healthcare data into at least one of a simple grid, standard grid, text or image view.

15. The method of claim 10, wherein the act of processing employs at least one of a plurality of information components and wherein the plurality of information components include at least one of a demographics component, an allergies component, a past medical history (PMH) component, a medication component, a labs component, an orders component, a clinical locator component, a diagnosis & procedures component; a radiology component, a dictation component, a pathology component, an electrocardiogram (EKG) component or a charts component

16. The method of claim 10, further comprising securing transmission of the requested healthcare data.

17. The method of claim 16, wherein the requested healthcare data is secured using SSL (secure sockets layer).

18. A system that facilitates secure network-based access to healthcare data, comprising:
means for authenticating a user;
means for processing a remotely-generated request from a user for healthcare data;
means for launching an information module based upon the request;
means for retrieving the healthcare data;
means for configuring the healthcare data as a function of the information module; and
means for presenting the healthcare data to the user.

19. The system of claim 18, further comprising:
means for establishing a session ID; and
means for associating the session ID to the authenticated user, wherein the association facilitates subsequent information requests.

20. The system of claim 18, wherein the information module is at least one of a demographics component, an allergies component, a past medical history (PMH) component, a medication component, a labs component, an orders component, a clinical locator component, a diagnosis & procedures component; a radiology component, a dictation component, a pathology component, an electrocardiogram (EKG) component or a charts component
